(19) United States
(12) Patent Application Publication
(10) Pub. No.: US 2009/0265251 A1
(43) Pub. Date: Oct. 22, 2009

(54) Systems and Methods for Searching a Defined Area

(75) Inventors: Scott Howard Dunlap, Woodside, CA (US); Dan Steinman, Palo Alto, CA (US); Jeff Piper, Palo Alto, CA (US); Josh Schaefer, Redwood Shores, CA (US); Johannes Erdfelt, San Jose, CA (US); Quyen Tran, San Jose, CA (US); Wesley Chun, Los Altos, CA (US); Paul Howe, San Francisco, CA (US)

Correspondence Address: FOUNTAINHEAD LAW GROUP, PC;Chad R. Walsh, 900 LAFAYETTE STREET, SUITE 200, SANTA CLARA, CA, 95050, US

(73) Assignee: NearbyNow, Los Altos, CA (US)

(21) Appl. No.: 11/948,884

(22) Filed: Nov. 30, 2007

(51) Int. Cl. G06Q 30/00; G06F 17/30; G06N 5/02; G06Q 10/00; G06T 11/20

(52) U.S. Cl. 705/26; 707/5; 707/2; 706/47; 705/28; 345/441; 707/E17.017; 707/E17.018; 707/E17.109

(57) ABSTRACT

Embodiments of the present invention include systems and methods for searching a defined area. In one embodiment, the present invention includes a method comprising receiving a plurality of product data, wherein the product data describes a plurality of products offered for sale by a plurality of businesses. Product data may be associated with a defined area, where the businesses each have a point-of-sale store located in the defined area. A user may enter a search request, and the system searches product data for a plurality of products in a plurality of point-of-sale stores in the defined area. The system outputs product data for point-of-sale stores located in said defined area matching said search request.

### BACKGROUND

The present invention relates to information processing including information acquisition, retrieval, and searching, and in particular, systems and methods for searching a defined area.

The growth of communication networks has led to an ever increasing amount of available information. A variety of electronic devices may be used to access information over a variety of communication media including the Internet or cellular networks, for example. As the amount of information has grown, software systems commonly referred to as search engines have appeared to help users find the information they desire. Search engines are typically based on keywords entered by a user. For example, a user may enter the phrase “watch.” In response to the user's input (or “search query”), a search engine may compare the keywords to the words found on websites all across the Internet. The search engine may return hypertext links to websites that match the search query (e.g., links to websites with watches).

While numerous search algorithms have been developed for increasing the speed, accuracy, and scope of searches, existing search engines still typically search across web pages based on the information entered into the search query and the information found on the web pages. Exiting search engines do not efficiently take into consideration other information about a user, such as the physical areas within convenient access to the user.

For example, while the Internet has enabled shoppers to find online stores that carry products and services they desire, it has done little to help shoppers find conveniently located local merchants who carry the items they seek. Often, search results from a contemporary search engine will return purchasing options from suppliers who have either no “brick and mortar” point-of-sale store where an item physically resides and can be purchased or the search engine will return results for suppliers who may be hundreds or even thousands of miles from the location of the purchaser. Additionally, while some limited “local” searching is available via on-line local “Yellow Pages” or “Directories”, such systems do not allow users to search for specific items or even categories of items available in each local store at a granular level.

Thus, there is a need for the improved systems and methods for searching. The present invention solves these and other problems by providing systems and methods for searching a defined area.

### SUMMARY

Embodiments of the present invention include systems and methods for searching a defined area. In one embodiment, the present invention includes a method comprising receiving a plurality of product data, wherein the product data describes a plurality of products offered for sale by a plurality of businesses. Product data may be associated with a defined area, where the businesses each have a point-of-sale store located in the defined area. A user may enter a search request, and the system searches product data for a plurality of products in a plurality of point-of-sale stores in the defined area. The system outputs product data for point-of-sale stores located in said defined area matching said search request.

In one embodiment, the present invention includes a computer-implemented method comprising receiving a plurality of product data, wherein the product data describes a plurality of products offered for sale by a plurality of businesses, storing the product data as a plurality of individual product data records, wherein each record describes an individual product, associating a portion of the product data records with a defined physical area, wherein said businesses each have a point-of-sale store located in said defined physical area, receiving a search request, searching product data records for a plurality of products in a plurality of point-of-sale stores located in the defined physical area, and outputting product data for said businesses with point-of-sale stores located in said defined physical area matching said search request.

In one embodiment, the method further comprises receiving product inventory data from a point-of-sale store in said defined physical area, the portion of product data records associated with the defined physical area comprising product data for a first business matching the inventory data from said point-of-sale store for the first business.

In one embodiment, associating a portion of the product data records with a defined physical area comprises associating a point-of-sale store of each business with the defined physical area and associating product data records from each business with the point-of-sale store in the defined physical area.

In one embodiment, the plurality of product data is received from a plurality of websites for said businesses.

In one embodiment, the method further comprises configuring an automated web content extraction program with one or more mapping rules for specifying the location of product data in a website and extracting the product data from said website of said business.

In one embodiment, the mapping rules map product data from a product web page on said website to fields of a product data record in a database.

In one embodiment, the defined physical area is represented by a unique identifier, and wherein associating a portion of the product data with the defined physical area comprises associating a portion of the product data with the unique identifier.

In one embodiment, the method further comprises storing the hours of operation for the first store, specifying a response time window, receiving a reservation pickup request, calculating the pickup time based on the current time, the response time window, and the hours of operation of said store.

In one embodiment, the method further comprises associating a portion of the product data records with a map image of said defined physical area, and outputting said map image and the location of each point-of-sale store having product data responsive to said search request.

In one embodiment, the method further comprises storing an electronic map of the defined physical area, associating a plurality of stores with location information for specifying the location of the store on said electronic map, and specifying the location of each point-of-sale store on the electronic map having product data matching said search request.

In one embodiment, the present invention includes a computer-implemented method comprising storing an identifier in a first record, the identifier representing a defined area, associating the identifier in the first record with a plurality of store records in a store table, wherein each store record corresponds to a point-of-sale-store in the defined area, associating a first store record from the plurality of store records with a first retailer record in a retailer table, the first store record corresponding to a first store in the defined area, programming a crawler with configuration information for retrieving information from a website of said retail business, the website comprising a plurality of products and corresponding product data, the configuration information comprising one or more rules for mapping product data from a product web page to fields of a product data record in a database, associating a plurality of product data records populated with data from said website with the first retail record, receiving inventory data corresponding to said first store record, the inventory data specifying products offered in said first store, filtering the product data records using the inventory data, wherein the filtered product data records describe products from said website that are offered in said first store, and associating the filtered product data records with said first store record, and in accordance therewith, associating the filtered product data records with the defined area.

In one embodiment, the method further comprises generating an index of the data in the database, receiving a search request for information within said defined area, accessing the product data associated with said defined area in response to the request, and generating a plurality of web pages, the web pages comprising product data in said defined area responsive to the search request.

In one embodiment, the search request comprises a search query and a specification of the defined area.

In one embodiment, the search request is a text message comprising a search query and a geocode, the method further comprising mapping the geocode to said identifier.

In one embodiment, the method further comprises storing the hours of operation for the first store, specifying a response time window, receiving a reservation pickup request, calculating the pickup time based on the current time, the response time window, and the hours of operation of said store.

In one embodiment, the configuration information further comprises one or more rules for identifying product categories.

In one embodiment, the configuration information further comprises one or more rules for identifying product web pages.

In one embodiment, the method further comprises storing map of the defined area in the first record and storing a location of said first store in said defined area in said first data record.

In one embodiment, the method further comprises storing map of the defined area in the first record and storing a location of said first store in said defined area in said first data record.

In another embodiment, the present invention comprises a computer-readable medium containing instructions for controlling a computer system to perform a method comprising receiving a plurality of product data, wherein the product data describes a plurality of products offered for sale by a plurality of businesses, associating a portion of the product data with a defined physical area, wherein said businesses each have a point-of-sale store located in said defined physical area, receiving a search request, searching product data for a plurality of products in a plurality of point-of-sale stores associated with the defined physical area, and outputting product data for said businesses with point-of-sale stores located in said defined physical area matching said search request.

In one embodiment, the method further comprises receiving product inventory data from a point-of-sale store in said defined physical area, the portion of product data associated with the defined physical area comprising product data for a first business matching the inventory data from said point-of-sale store for the first business.

In one embodiment, associating a portion of the product data with a defined physical area comprises associating a point-of-sale store of each business with the defined physical area and associating product data from each business with the point-of-sale store in the defined physical area.

In one embodiment, the plurality of product data is received from a plurality of websites for said businesses.

In one embodiment, the method further comprises configuring an automated web content extraction program with one or more mapping rules for specifying the location of product data in a website and extracting the product data from said website of said business.

In one embodiment, the defined physical area is represented by a unique identifier, and wherein associating a portion of the product data with the defined physical area comprises associating a portion of the product data with the unique identifier.

In one embodiment, the method further comprises storing an electronic map of the defined physical area, associating a plurality of stores with location information for specifying the location of the store on said electronic map, and specifying the location of each point-of-sale store on the electronic map having product data matching said search request.

The following detailed description and accompanying drawings provide a better understanding of the nature and advantages of the present invention.

### BRIEF DESCRIPTION OF THE DRAWINGS

FIG. 1 illustrates a system according to one embodiment of the present invention.

FIG. 2 illustrates a method according to one embodiment of the present invention.

FIG. 3 illustrates a system according to another embodiment of the present invention.

FIG. 4 illustrates a method according to another embodiment of the present invention.

FIG. 5 illustrates a system according to another embodiment of the present invention.

FIG. 6 illustrates a method according to another embodiment of the present invention.

FIG. 7 illustrates a system according to another embodiment of the present invention.

FIG. 8 illustrates extracting product data from a website according to another embodiment of the present invention.

FIG. 9 illustrates configuration data for a crawler according to another embodiment of the present invention.

FIG. 10A illustrates a schema for storing information according to another embodiment of the present invention.

FIG. 10B illustrates example database tables for storing information according to another embodiment of the present invention.

FIG. 11 illustrates a method according to another embodiment of the present invention.

FIG. 12 illustrates a webpage according to one embodiment of the present invention.

FIG. 13 illustrates a webpage of search results for a shopping mall according to one embodiment of the present invention.

FIG. 14 illustrates a map including store locations according to one embodiment of the present invention.

FIG. 15 illustrates product data results of search in a shopping mall according to one embodiment of the present invention.

FIG. 16 illustrates a results page for a product with a check availability feature according to one embodiment of the present invention.

FIG. 17 illustrates a results page for a product with a reservation feature according to one embodiment of the present invention.

FIG. 18 illustrates method of reserving products according to one embodiment of the present invention.

### DETAILED DESCRIPTION

Described herein are techniques for information processing. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

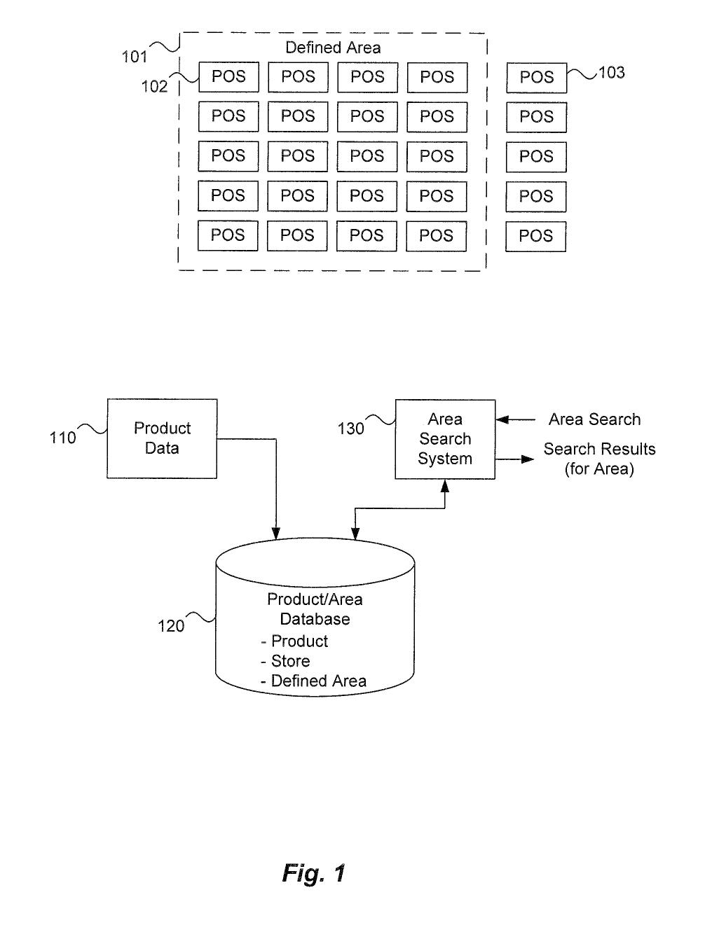

FIG. 1 illustrates a search system according to one embodiment of the present invention. FIG. 1 shows a defined area 101 including a plurality of point-of-sale (“POS”) stores 102. Other POS stores 103 are not included in defined area 101. These stores are physically located outside the defined area. Defined area 101 may be a defined physical area. Examples of defined physical areas 101 include, but are not limited to, a shopping mall, a strip mall, a precinct, a district (e.g., a shopping district), a specific structure, a campus, a neighborhood, a city, a county, a state, or any other location having geographic boundaries. Examples of POS stores may be outlets of larger retailers such as a GAP® store, a MACY'S® store, or even individual small local business POS stores that are not part of a larger retail chain. It is to be understood that while the present invention is described herein using shopping for products as a specific example, the technology and techniques described below are advantageous in other applications. It is also to be understood that the term products as used herein includes both goods and services offered for profit (e.g., sale, lease, etc. . . . ) by a vendor.

Features and advantages of the present invention include receiving product data and associating the product data with a defined area so that users can search the data for goods or services offered within the defined area (i.e., products that are either currently available or products that are offered by a store and may be available at a later time for customer pickup). For example, product data may be associated with a shopping mall, and users may search for products and discover that the desired products are available at their local mall for purchase. Referring to FIG. 1, product data 110 is received, and may be stored in a database 120. The product data 110 may be comprised of individual data elements corresponding to specific products, for example. Product data elements (or records) may include a product name, description, price, and other product specific information, for example. While the present embodiment and other embodiments below are described using a database as the storage technology, it is to be understood that other data repositories for storing and searching for data could be used. The product data may be associated with a defined area. For example, if a particular product is known to be sold at a POS store 102 within the defined area, the product data for such product may be associated with defined area 101. Similarly, product data for a plurality of products may be associated with defined area 101 if the products are sold within such defined area. However, some products may not be associated with the defined area 101. For example, if a product is sold at POS store 103, the product data for such product may not be associated with the defined area 101. User's may search for products by entering search terms into area search system 130. Search system 130 may be configured to perform an area search of the defined area. An example search term is “watch”. In response to this search term, an area search will be made across all product data associated with the defined area. If a product data record includes the term “watch” (e.g., in the description) and the record is associated with the defined area, then the record will be retrieved. The retrieved records resulting from the search may then be displayed. For example, a search on “watch” may indicated that there are 256 types of watches for sale at a specific mall, and may further include the price of each watch, a description of each watch, an image of each watch, and other information. However, if POS store 103 sells watches and if such watches are included in the product data, these watches will not be returned in response to the search query because these products are not associated with the defined area (although they may be associated with another defined area).

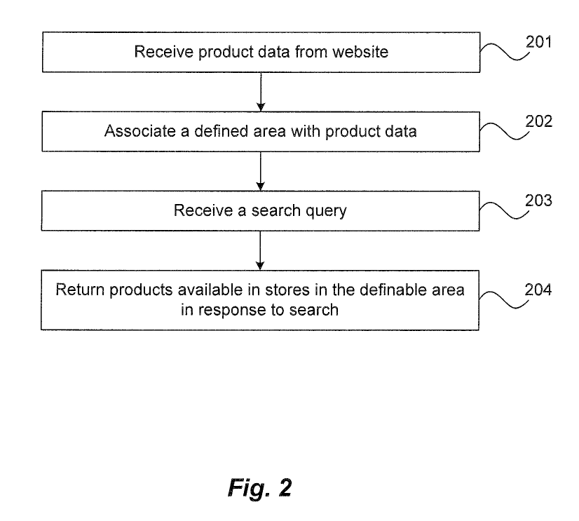

FIG. 2 illustrates a method according to one embodiment of the present invention. At 201 product data may be received. For example, in one embodiment described in more detail below product data is received from one or more websites. Product data may describe a plurality of products offered for sale by a plurality of businesses and may include, for example, product name (i.e., product title), price, sale price, a product identifier (e.g., SKU or other ID), a product description, an image or picture of the product, category or sub-category information (e.g., shoes/sports/running/Nike® Cross-Trainers), URL of the product website, URL of where the product can be purchased from the website, product physical attributes (e.g., sizes, colors, long/short sleeve), availability information including purchasing options (e.g., in-store only, on-line only, both, or on-line purchase with in-store pickup), stocking information (e.g., 10 bags available in store), or date of availability (e.g., release date December 1), for example, and meta information including any other information to describe the product such as descriptive keywords (e.g., a handbag may be referred to in the alternative as “a clutch” or “a hobo” bag). At 202, the product data is associated with a defined area. Associating the product information with a defined area allows searching product data for a plurality of products associated with the defined area. For instance, at 203 a search query is received. The search query may include search terms to be searched for (e.g., “watch”). In response to the search query, products associated with the defined area are returned. If the defined area is a shopping mall, for example, the results output by the search system may correspond to products available at the shopping mall.

Referring again to FIG. 1, one embodiment of the present invention further includes storing POS information. For example, as mentioned above, the product data may describe different products available from different businesses. Each of the businesses may have corresponding POS stores where consumers can receive the goods or services directly. Some of these POS stores may be located in the defined area and others may be located outside the defined area (possibly in another defined area). By storing POS store information with the product information and associated defined area, embodiments of the present invention allow a user to search product data for a plurality of products in a plurality of point-of-sale stores associated with the defined area. For example, if a user enters the search term “Movado® watch” into a area search system, then the area search system may output all Movado® watches available in the defined area by POS store (e.g., MACY'S®—Movado® search results list; Neiman Marcus®—Movado® search results list; etc. . . . ). More generally, the search system outputs product data for the businesses with point-of-sale stores located in said defined area matching said search request.

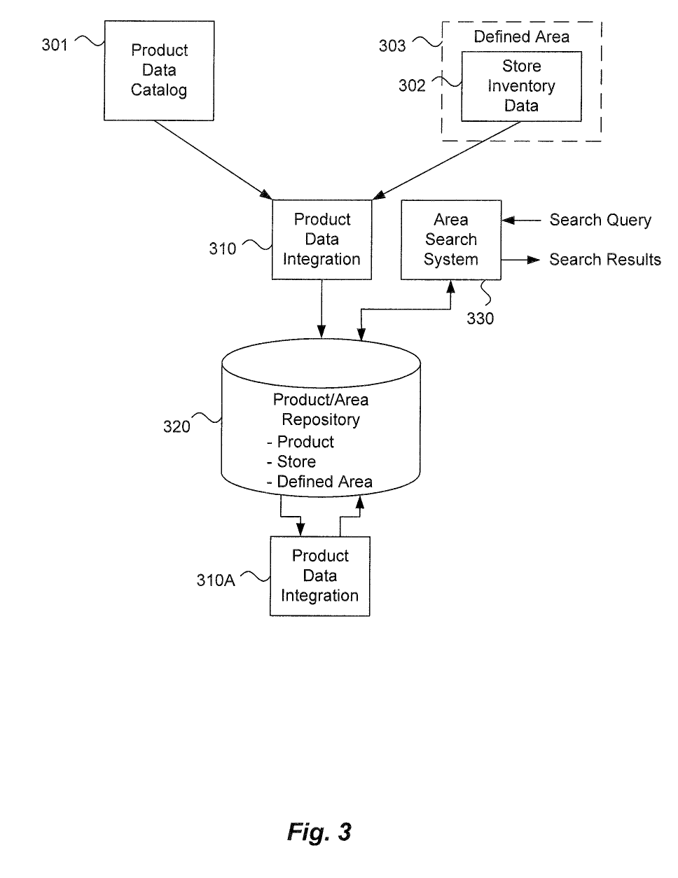

FIG. 3 illustrates a search system according to another embodiment of the present invention. In this embodiment, product data may comprise a product catalog from a business's website. For example, a business may offer an on-line store through the business's main domain name. Such on-line stores may list most or all the products the business offers, which in some cases are organized as categories and subcategories. A product data catalog from a website or other source may be received and used to populate repository 320. Additionally, inventory data 302 from the POS store of the business within the defined area 303 may be accessed and received. For example, if a business has 100 store locations, including 1 store located in the defined area, then the inventory data for the store in the defined area may be received and used for area searching. In one embodiment, product data integration software 310 may receive the product data catalog 301 and inventory data 302 for the store in the defined area. The product data catalog 301 may contain a list of products offered by the business, including descriptions of such products and other product data described above. The inventory data may be presented either by inclusion (the store offers product X) or exclusion (the store does not offer product X) from the catalog, for example. In one embodiment, the inventory data comprises an identification of the product (e.g., a product ID), categories of products (e.g., the store offers shoes/sport/running/—i.e., all running shoes), or both. For instance, product data integration software 310 may receive the inventory data as a plurality of identifiers (product IDs or category IDs) available in the POS store in the defined area. The integration software may match up the received IDs with corresponding IDs in the product data catalog to determine which products from the catalog are in the store inventory data. In particular, in one embodiment, if a product ID is received from the POS store, then the system matches up the product ID from the catalog and designates that POS store as carrying the product having the received product ID. Similarly, if a category ID is received from the POS store, then the system matches up the category ID from the catalog and designates that POS store as carrying all the products within the category corresponding to the category ID. In yet another embodiment, the specific number of products available (e.g., the number of units) in the store may be received. The search repository may then be populated by storing the portion of the product data catalog that matches the inventory of the POS store located in the defined area. This same process may be carried out for other businesses with stores in the defined area so that product data in the repository 320, which is associated with the defined area 303, comprises the product data for products in stock at some or all of the stores in the defined area. A user may then enter a search query into area search system 330. Area search system 330 searches the product data that is in the inventories of the stores in the defined area. For example, if a user enters the search term “Nike® running shoes”, then the system will search the repository for product data that is in stock in the stores in the defined area with matching terms. For instance, a Foot Locker® in the defined area may have 3 different styles of Nike® running shoes in stock, a Big 5 Sporting Goods® in the defined area may have 4 different styles of Nike® running shoes in stock, and a Sports Authority® may have 4 different styles of Nike® running shoes in stock. The system outputs products that are available (in stock) in the stores in the defined area that match the search terms. Therefore, the system in the example search above may output the names of the businesses in the defined area and links to pages describing the results—e.g., “Foot Locker®” followed by links to web pages for each Nike® running shoe type in stock, “Big 5 Sporting Goods®” followed by links to web pages for each Nike® running shoe type in stock, and “Sports Authority®” followed by links to web pages for each Nike® running shoe type in stock. The web pages presented to the user in response to the search query may be created using the product data catalog, for example. A more detailed description of the results generated in response to a search according to embodiments of the present invention is described in more detail below.

Additionally, it is to be understood that identifiers are just one example of the store inventory data that could be received from the POS store locations. It is to be understood that other store inventory data may also be sent, including product names, SKUs, or other information to identify products or categories of products, for example. In one embodiment, the store inventory data (or “in-store” data) includes one or more of product name, product type, an identifier (e.g., SKU or ID), category or subcategory, product description, an image or picture of the product, list price, sale price (if any), in-store discounts (if any), product attributes, available sizes and colors or any of the product information described above. The inventory data may be matched against the product data catalog and stored in the repository. In one embodiment, if products are in both the catalog and inventory, then such products are available at the POS store, if a products is in the catalog but not the inventory, then such products may be designated as available for “on-line purchase”, and if products are in the inventory data but not the catalog, then such products are designated as “no product catalog information available.” In some embodiments, inventory data from a store may include additional data or different data than the product data catalog. In this case, the “store specific data” may be used to supplement or override the catalog data. For example, specific stores may have local promotional sales or items not available through the central business entity. This data may be included in the inventory data with additional specifications (e.g., flags) indicating that particular pieces of data are supplemental to or replacements for catalog data. In the above example, product data integration was illustrated at 310 as occurring before storage in the repository 320. However, it is to be understood that the product data catalog and store inventory data may be stored in repository 320 and then integrated using product data integration 310A after storage.

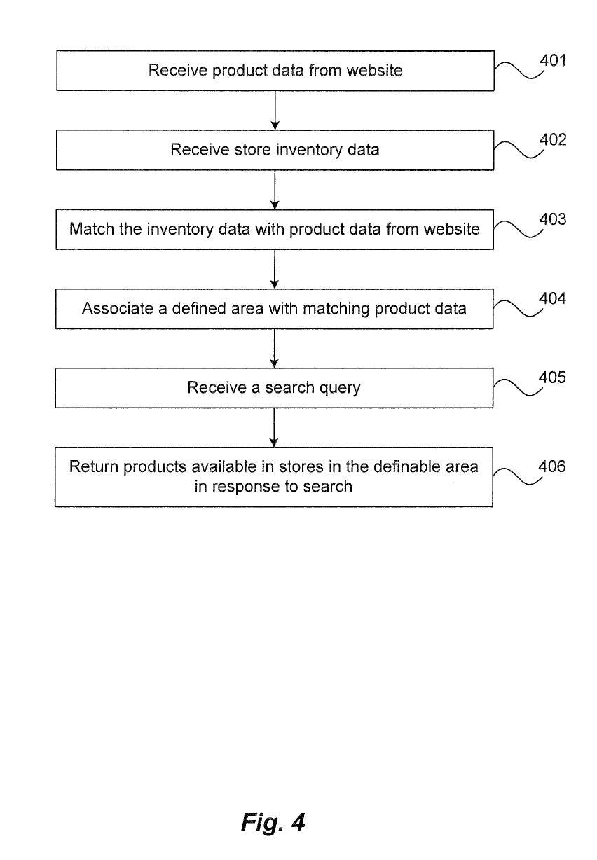

FIG. 4 illustrates a method according to another embodiment of the present invention. At 401, product data is received. As mentioned above, the product data may be product data from a website including a complete or semi-complete listing of the products and product categories offered by a particular business. The data may be available on the business's website for example. At 402, store inventory data is received. The store inventory data may be for a “brick and mortar” store of the business located within a defined area of interest. The product and inventory data may be received over a network, locally by loading a file received from the business and/or store, or manually via data entry, for example. At 403, the inventory data is matched with the product data. The result may be product data that is in stock in the store of the business. Product data and inventory data may be collected and processed as set forth above for any number of businesses in a defined area. At 404, the product data in the store's inventories are associated with a defined area. Accordingly, a user may search across products in different stores in a defined area to determine what products are in stock for purchase. At 405, a search query is received. At 406, the products that include product data responsive to the search query, and which are also in stock in a store in the defined area, are output by the system and returned to the user.

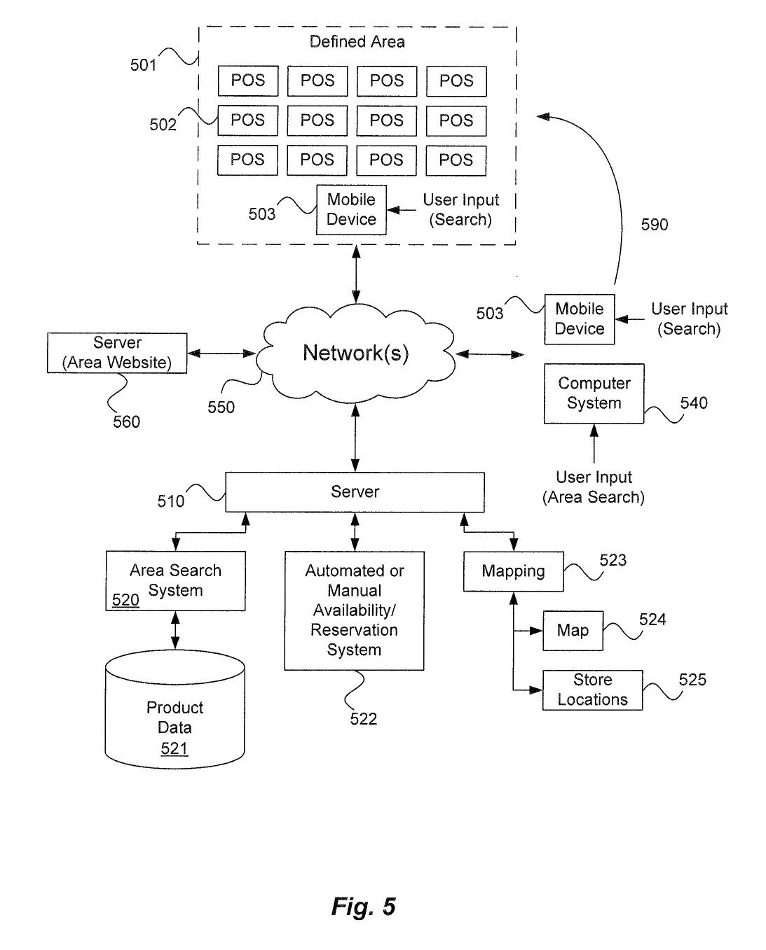

FIG. 5 illustrates a system according to another embodiment of the present invention. This example illustrates another embodiment of a system for searching in a defined area. Here, the defined area 501 may be a shopping mall located at a particular geographic location, for example. A plurality of point-of-sale stores 502 are located inside the shopping mall, and the stores may each be located at particular locations in the mall. User's may search for products available at shopping mall 501 by entering a search query into a computer system 540 (e.g., at home) or into a mobile device 503 (e.g., at home, on the go, or at the mall). The search query is sent over one or more communication networks 550 (e.g., a wireless cellular network or the Internet, or both) to server 510 and area search system 520. Product data for products in the mall may be stored in a product data repository 521. Area search system 520 searches product data in repository 521 associated with the defined area 501 and returns product data satisfying the search query.

As mentioned above, product data may be accessed and received from a retail chain website (e.g., “www.gap.com” or “www.apple.com”) or related on-line store for the business. Additionally, inventory data from the stores 502 in the mall may be received and used to determine the products currently in stock at specific stores in the mall, The products available for sale in the mall may further be associated with the defined area—here a shopping mall. As described in more detail below, in one embodiment the defined area may have a unique identifier. For example, a shopping mall may have a specified ID of number or letters (or both) or the specific unique name of the mall may be used. Each product data entry is associated with a store 502 (i.e., a store that carries such product in its inventory). For example, if a product is available at a store in the mall, either in current inventory or available for on-line purchase and in-store pickup, for example, then the specific store may be associated with the product data for such product. Each store may also have an ID for associating product data with a particular store. Additionally, each store may be associated with the defined area (e.g., the mall) by specifying an association between the store and the mall (e.g., store ID ←→ area ID). In this specific example, because the product data is associated with a store 502, and each store 502 is associated with a defined area 501, the product data in repository 521 may be searched based on defined area.

As mentioned above, a user may enter an area search query into a computer system 540 or mobile device 503. For example, a user may desire to purchase a specific product, and may perform a search of a local shopping mall to determine if the specific product is available in the mall. The user may conduct the search from a computer system at home, at work, or in a coffee shop with wireless access, for example, to be certain the item is available before travelling to the mall. Accordingly, if the item is not available at one location, the user may search for the item at another defined area prior to traveling to the defined area to purchase the item. The user may further shop for the best price at different locations prior to making the trip to purchase item at any one location (e.g., a Rolex watch may be offered for sale at a lower price in a shopping outlet in a strip mall rather than at a particular large full service indoor mall). In one embodiment, the user enters the search query into a computer system 540 and then, if the search results show that the desired product is available at a particular location for a satisfactory price, the user travels 590 to the defined area to purchase the item. In another embodiment, the user enters the search query into a mobile device 503 (e.g., at the mall). The user may then coordinate shopping at the mall based on what is available. Additionally, a user may send a search query and receive results as a text message. In a text messaging implementation, a user may type in a geocode (“VF”=Valley Fair Mall). The geocode may be sent to the area search system over a cellular network and the Internet. The received text message geocode may be mapped or otherwise transformed into an ID for the defined area that is recognized by the search system. Additionally, the user may specify the search query. The area search system may used the mapped geocode and search query from the text message to perform an area search and return the resulting product data for stores in the defined area to the user as a text message.

In one embodiment, the defined area may have a dedicated website running on a server 560, such as the website for a mall. For example, a mall website may incorporate the functionality of the area search engine and allow users to enter search queries into the mall's website directly. The search queries may be forwarded automatically, and without additional user interaction, to server 510 and area search system 520 to execute the search of the defined area. Area search system 520 may return product data satisfying the search query, and server 510 may generate and send web pages of search results. The product data searched and retrieved from repository 521 may include numerous specific products available at a number of different stores in the mall. Web pages may be generated that display the product data grouped by store, for example. The web pages sent to a user in response to the search may include product data received from the website of the larger business (e.g., the retail website) of which the store is an outlet, for example. The resulting web pages may include an image of the store's logo, which may also be the larger business's logo, images of the products responsive to the search query, descriptions of the products, prices, or other product data described above. The resulting web pages may further include store specific data, such as store specific prices, sales prices, or other store specific promotions or items. A more detailed description of the web pages generated by the system in response to a search request is provided below.

The resulting web pages may further include an electronic mechanism (e.g., an electronic button) for automatically or manually checking availability or reserving the product, or both. As described in more detail below, if a user invokes the check availability function, the availability of the product will be determined and the user will be notified of the result. For example, the system may automatically update the inventory data from the store or request a specific inventory item from the store to verify that a particular item is currently in stock. Alternatively, the system may generate an alert to a customer representative who may then call the store and verify the availability of the item manually. The user may then be notified electronically of the availability of the item. Similarly, if a user invokes the reservation function, the item will be placed on reserve and the user will be notified of the result. For example, the system may automatically signal the store to place a particular item on reserve. Alternatively, the system may generate an alert to a customer representative who may then call the store and manually instruct employees in the store to place the item on reserve.

The system may further output a map of the defined area, and may further output the location of each store on the map having one or more products responsive to the search query. For example, the system may include a mapping software component 523. A map of the defined area (e.g., a shopping mall) may be stored at 524. Additionally, the location of each store on map 524 may be specified, and the store locations may be stored at 525. For example, the locations on the map may be specified using (x, y) coordinates for the map, and the location of each store may be specified by the specific (x, y) coordinates of each store on the map. Each store may then be associated with location data, such as an (x, y) coordinate, for example. For instance, specifying the location of stores on the map may be performed by displaying the map to a developer, moving the mouse pointer over the location of the store on the map, and associating the resulting (x, y) location of the mouse pointer with the store (e.g., The Gap® is located at coordinates (x1, y1) on the map of the mall). In response to a search query, product data satisfying the search query will be retrieved from the product data repository. The product data may be associated with a particular store. The store information (e.g., a store ID) may be used to access the location information 525 for the store on the map 524. For example, if (3) different stores in a mall offer one or more products that satisfy the search query, then three (3) different store location values (e.g., (x, y) coordinates on a map) may be retrieved to specify the location of each store on map 524. The map 524 may be incorporated into a web page for displaying the mall to the user, and a graphical object (e.g., an icon such as a pointer or a logo of the store) may be displayed on the map using the store location information 525 so that the graphical object appears at the position of the store on the map. The user is then provided with directions within the defined area to the specific location of the store where the desired product may be acquired.

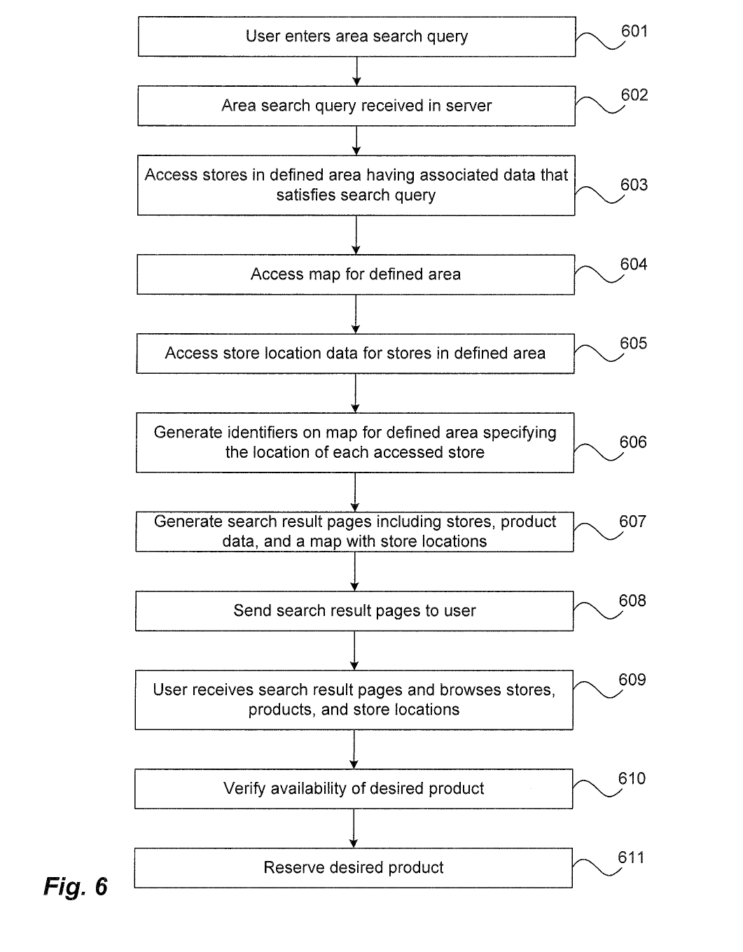

FIG. 6 illustrates a method according to another embodiment of the present invention. At 601, a user enters an area search query. At 602, the area search query is received in a server. At 603, point-of-sale stores in the defined area having associated product data that satisfies the search query are accessed. For example, if the search query is “watch” and a particular store in the defined area is associated with five different products with the word “watch” in the product title, then the product data for the five products and store data for the particular store is accessed and retrieved in response to the query. At 604, a map of the defined area may be accessed (if available). At 605, the store location data for the stores in the defined area may be accessed. For example, the stores accessed in response to the search results may be used to retrieve store location data for identifying the location of each store on the map. At 606, identifiers (e.g., graphical objects) are generated on the map of the defined area for specifying the location of each accessed store. At 607, search result web pages including the stores, product data, and a map with specified store locations are generated. At 608, the search result pages are sent to the user. At 609, the user receives the search result pages and may browse the stores, products, the map, and the store locations on the map. At 610, a user may verify the availability of a desired product. At 611, a user may reserve the desired product for pick up at a later time.

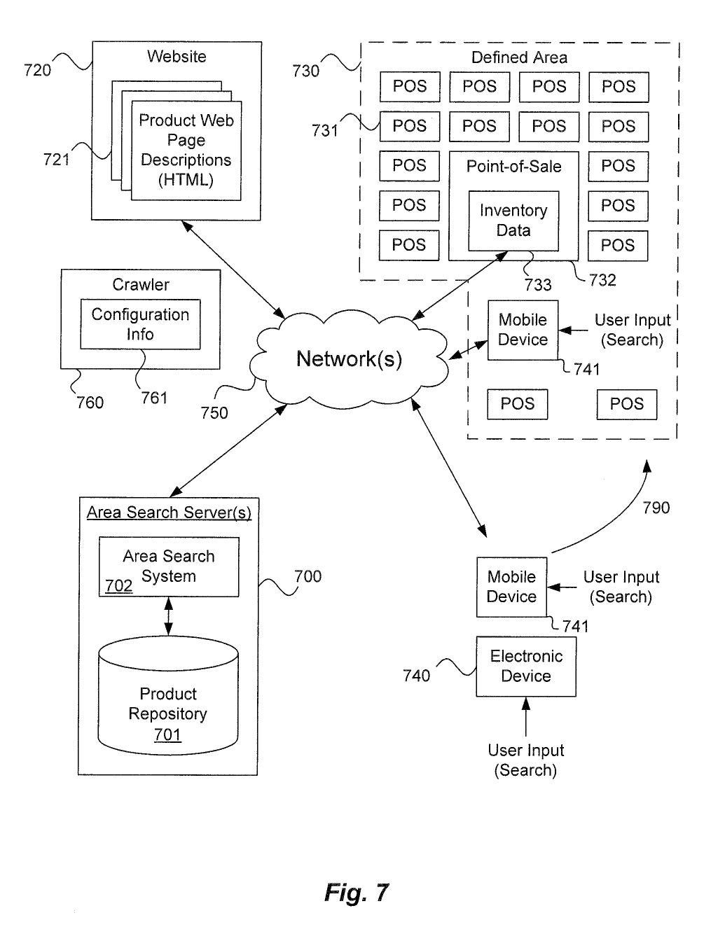

FIG. 7 illustrates a system according to another embodiment of the present invention. In this example, an area search server system 700 receives product data from product web pages on a website of a business and store inventory data from the business's stores in a defined area. The data is stored using a data model that supports searching the data across a defined area. For instance, system 700 may include one or more servers coupled to a network such as the Internet. The servers may include a search system 702 for searching product data in repository 701 across defined areas. The product data in repository 701 may be extracted from one or more websites 720. For example, as mentioned above, a business such as a retail chain may have a single website with descriptions of the products carried by the retail chain. The website may be an “on-line” store where user's can purchase products on line rather than traveling to one of the business's outlet stores. Accordingly, the website may include product data described above that may form a catalog of the products available from the business. The product data on website 720 may be available on a plurality of product web pages 721. The product web pages 721 may include detailed information about the products, for example. In one embodiment, the present invention includes retrieving the product data from one or more websites using a customized automated web content extraction program (i.e., a customized “crawler” or “web crawler” also known as a spider or robot). A crawler is a program or script which browses websites on the Internet automatically. In one embodiment, a crawler 760 is programmed with configuration information 761 for mapping specified elements of web pages to specific product data fields. The data from product web pages on retailer websites may then be retrieved and used to populate product repository 701. The following is an example of the product data fields retrieved from a website: Product Title, Description, Price, Image, Product ID, SKU, and Category information (e.g., “mens/pants/casual/”).

Additionally, a defined area 730 may have POS stores 731 that are outlets of different businesses and offer products corresponding to the products on each business's website. Users may enter search queries into a computer system or mobile device to search the product data offered by the stores in the defined area. These stores 731 may offer many or all of the same products as found on the websites 720 of the parent companies. Stores 731 corresponding to the websites 720 may maintain inventories of such products or categories of products. As described above, the inventory data may be received and stored electronically. For instance, the inventory data 733 for POS store 732 corresponding to website 720 may be received by the system 700 and used to determine the products from website 720 available at the POS store in defined area 730. An example schema for managing data from the website and POS store for the defined area is described below. In one embodiment, optional third data input may be received from either the store or the retailer for specifying price corrections or sales corrections. Such data may include information about pricing of products that reflect geographic differences (e.g., a handbag may be $149 at store 1 and $144 at store 2). The data may also include information about pricing of products that are different from the pricing collected from the website (e.g., a handbag sells for $149 online, but is $125 in store 1). The data may further include information about sales and markdowns and the dates to enforce them (e.g., product A is on sale from date 1 to date 2 for $100). Such data may be matched up with or merged into the website or inventory data, for example, to incorporate the additional information. In one embodiment, inventory data and supplemental data may be received automatically from the store in electronic form. In another embodiment, the data may be stored in a file in a variety of formats, such as an Excel, Quickbooks, an inventory tracking software file, or a comma separated value file, and transferred over one or more networks (e.g., using FTP or even email). In other embodiments, the data may be manually entered into a website and loaded into the repository.

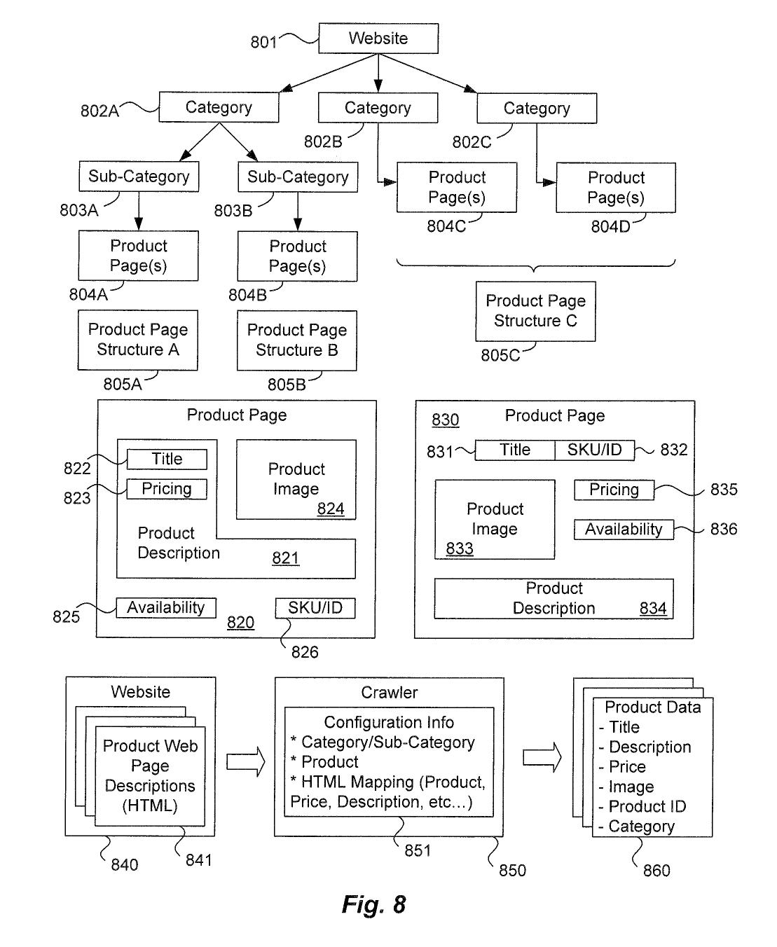

FIG. 8 illustrates extracting product data from a website according to another embodiment of the present invention. This example illustrates the logical structure of a website. Website 801 typically includes a main page (i.e., the root) with links to other web pages for categories (classes or types) of goods or services. For example, the main page of a clothing website may include categories for “men”, “women”, “teens” and “children”. As another example, a general retail store may have categories for “clothing”, “bed/bath”, “kitchen”, “toys”, “electronics”, and “garden.” Categories of a main website page are illustrated at 802A-C. Many categories of products will have additional categories (interchangeably, “subcategories”). For instance, a categories of “electronics” for the general retail store above may include “Audio”, “TV”, “Camcorders”, “Cameras”, “GPS Navigation”, “Computers”, and “Accessories.” Subcategories are illustrated at 803A-B.

In many implementations, many pages share a common structure. In particular, pages that are dedicated to individual products may have the same general structure for products in the same category, and may even have the same structure for products across multiple categories or even across the entire website. For example, a web page for subcategory 803A may allow users to access multiple specific products that are displayed on product pages 804A. Similarly, a web page for subcategory 803B may allow users to access multiple specific products that are displayed on product pages 804B. The product pages 804A may have a common web page structure 805A, which may correspond to a common underlying code structure for the page, for example. Similarly, the product pages 804B may have a common web page structure 805B. Likewise, product pages 804C and 804D may have the same web page structure 805C. Alternatively, all the product pages on a website may share the same web page structure.

Two different web page structures are illustrated at 820 and 830. These two web page structures are just two examples of a wide variety of web pages that may include product data to be retrieved using the techniques described herein. In web page structure 820, a description of the product 821 is presented as left justified text that wraps around a product image 824. In this example, the title 822 and pricing 823 are embedded in the text. Information about availability 825 and product SKU/IDs are both provided under the product description. Alternatively, in example product page 830, the title 831 and product SKU/IDs 832 are presented at the top of the page. A left justified product image 833 is positioned under the title, and the pricing 835 and availability 836 are positioned to the right of the image. In this example, the product description 834 is positioned at the bottom of the page.

Embodiments of the present invention include programming a crawler to retrieve product data from web pages and map elements of the web pages to specified product data fields according to defined rules. For example, product data provided in web pages 841 on a website 840 may be retrieved by crawler 850 configured with rules to identify specific categories and product page structures, and map the elements of the different product pages to specific product data fields. For example, a crawler may be configured with a rule to identify categories (e.g., product pages in categories 802B) and, for each product page in this category, a value may be assigned to the “category” field of the product data generated from pages in the category (e.g., pages 804C). The category may be predefined or extracted from the website itself, for example. Similarly, the crawler may be configured with rules to identify product pages. For example, a rule may be specified so that the crawler identifies all pages 805C as product pages. In some implementations, all product pages across a website may be identifiable using the same rule, but in other website implementations, multiple rules may be required to identify all product pages available. Furthermore, the crawler may be configured with rules to identify specific product data elements in a web page and map the product data elements to product data fields to be stored in a repository. For example, the crawler may be configured with a rule to identify the location of the title. For page 820, such a rule may specify that the title 822 is embedded in the product description 821. In page 830, the rule may specify that the title 831 located at the top of the page and to the left of the SKU/ID 832. Since many pages are programmed using HTML and JavaScript, the rule may identify HTML or JavaScript and map data based on the web page code to specific product data fields. For example, the title, price, SKU/ID, product image, product description, and availability may be identified and mapped to corresponding fields in a database by defining rules to identify the code constructs in page 820 that specify the structure of the page. Similarly, the same data from page 830 may be identified and mapped to fields in a database, but would require defining different rules because the structure of page 830 is different from page 820 so the HTML and JavaScript code constructs for the page are different.

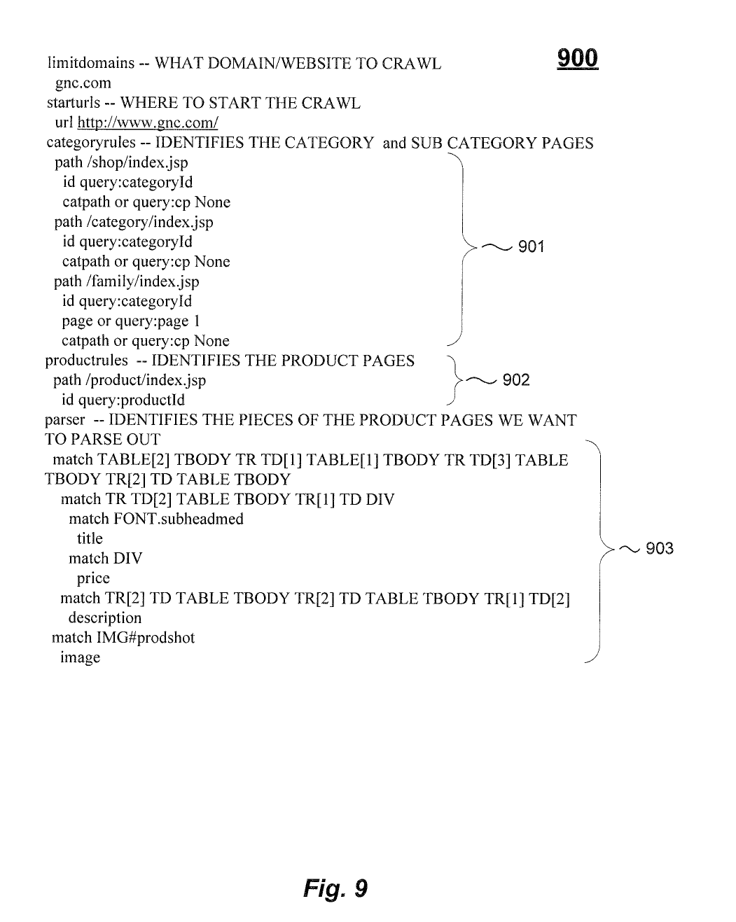

FIG. 9 illustrates configuration data for a crawler according to another embodiment of the present invention. Configuration data 900 for the crawler includes three sets of rules. First, category rules 901 identify the categories for products on the website. Category information is retrieved based on the category rules and stored in the product data records.

For example, a crawler may first build a table including a field for category codes found in the websites URL for each category and another field associate a category description for each code (e.g., code 1=men's clothing, code 2=toys, etc. . . . ). The crawler may then map category codes from the URL for the website to category descriptions, and either or both of the category codes or category descriptions may be stored in a product data record for each product. Second, product page rules identify product pages on the website. Websites will typically include specific pages dedicated to describing individual products that include a variety of product data that may be extracted. However, some websites may include multiple products on a single page. The third set of rules may be used to identify specific elements of the product pages to be retrieved. For example, rules 903 identify HTML in a web page where specific product data elements are located and map the product data elements to product data fields. In this example, the title, price, description, and an image of the product are extracted from the web pages and used to populate data fields for product data records a database.

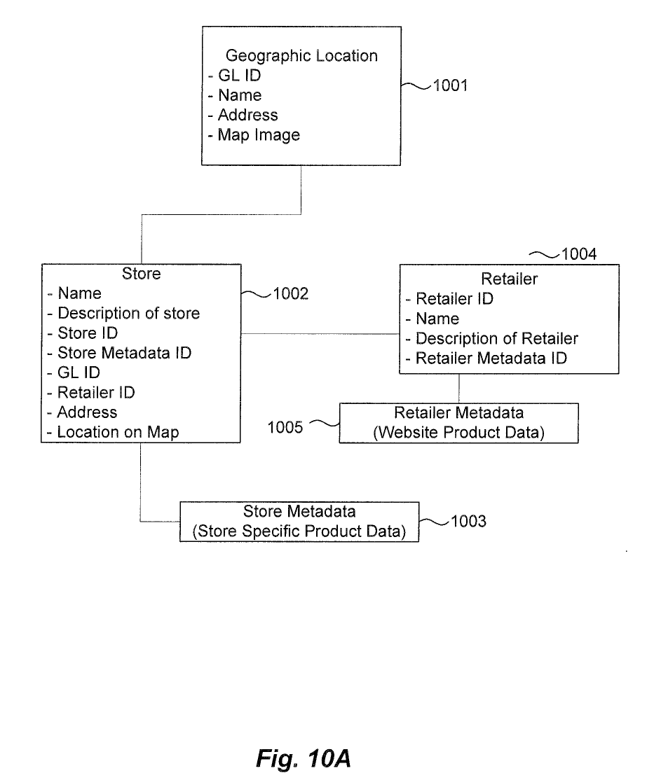

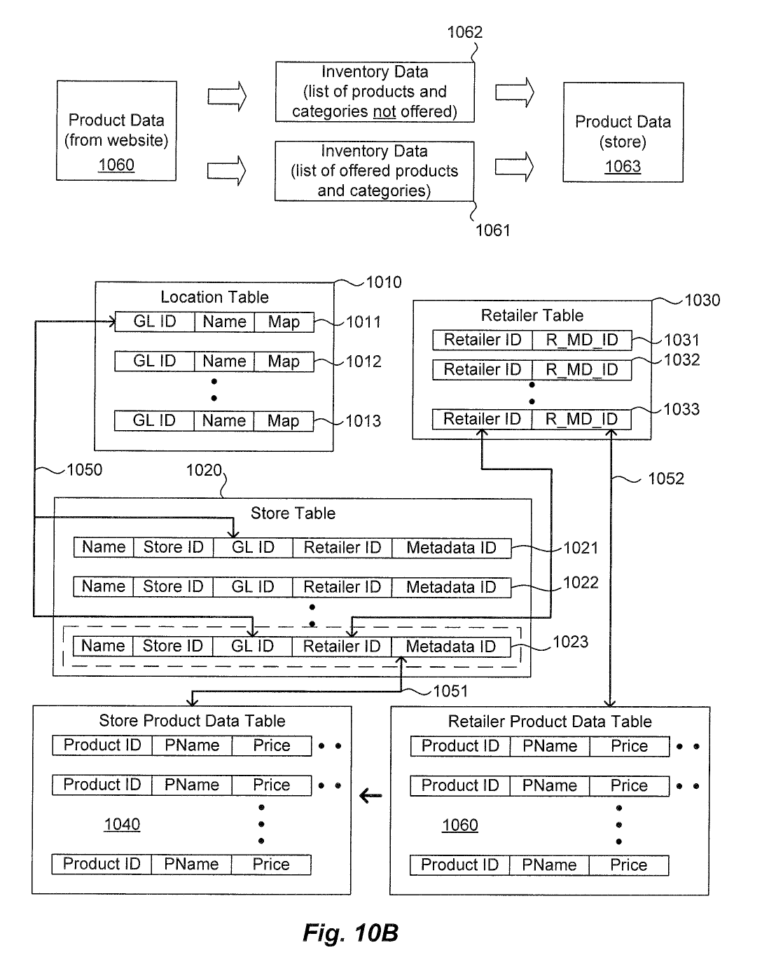

FIG. 10A is an example schema for storing information according to another embodiment of the present invention. In this example, defined areas may be stored in a geographic location table having schema 1001. For example, for each defined area, the system may store an identifier (e.g., a geographic location ID or “GL ID”), the name of the area, the address (if any). The address may be displayed to the user as part of the search results, for example. In one embodiment, the address may be forwarded over a computer network to a third party computer and used to retrieve mapping information for the mall. For example, if a user enters a search of a defined area, an address for the defined area may be forwarded to a map server and a map describing the geographic location of the defined area may be returned and incorporated into a web page for presentation to the user with the search results. Furthermore, the system may store a map image of the defined area as described above. A system may store a plurality of defined areas using some or all of the data fields described above. Each defined area may be associated with one or more store tables having schema 1002. Typically, a defined area will be associated with many stores, so there is a one-to-many relationship between a geographic location schema 1001 and store schema 1002 (i.e., one defined area to many stores). As illustrated by schema 1002, each store table may include a store ID and a GL ID for associating the store to one or more specific defined areas. Additionally, store schema 1002 includes a retailer ID, which may be used for associating a store to a particular retail chain or website where product data has been retrieved from. Additionally, the address of the store, the name of the store, a store description may be stored as fields for each store. Moreover, as mentioned above, each store's location on a map may be stored so that if a store is returned in response to a query, an identifier for the store may be graphically displayed to a user at the specific position of the store on the map of the defined area. Detailed product data comprising numerous data records for each product may be stored in a store metadata table. The store table is associated with the store metadata table and the store specific product data using store metadata ID. A retailer table may have a schema as shown at 1004. In this example, each retailer will have a retailer ID field, name field, retailer description, and a retailer metadata ID for associating the retailer with a retailer metadata table that stores product data retrieved (e.g., from the retailers website). Other retailer specific information may also be stored in a retailer table, such as a logo for the retailer that may be displayed in search results, for example. Since a particular retailer may have many outlet stores (e.g., Target® or BestBuy®), there is typically a one-to-many relationship between the retailer schema 1004 and store schema 1003 (e.g., one retailer many stores). As mentioned above, retailer and store tables further have associated tables for storing product data. For example, the product data retrieved from the retailer websites may be stored in retailer metadata table 1005. Retailer metadata table, therefore, may store a plurality of records corresponding to the specific products available on the retailer's website. Each product record may have a plurality of fields populated by elements of the website and product web pages. Inventory data from the stores may be used to populate the store metadata tables with the specific product data for each store as described below.

In one embodiment, the product data is first stored in the retail metadata tables. Inventory data is then received as ID's indicating the products each store has available. For example, if the inventory data includes product ID #12345, and product ID #12345 represents a specific brand of Polo® shirt, then the corresponding product data for the specific brand of shirt is transferred from the retail product data table to the store product data table. Similarly, if the inventory data includes category ID #54321, and category ID #54321 represents all men's Polo® shirts, then the corresponding product data for all men's Polo® shirts are transferred from the retail product data table to the store product data table. Accordingly, the inventory data may be used as a filter for transferring the retailer product data to each stores product data. The above example illustrates using the inventory as a positive filter for filtering in the specified data. As mentioned above, inventory data may be used to indicate what is not available in each store. In this case, the entire retailer product data is transferred to the store data except the data specified in each store's inventory data. This would be an example of negative filtering or filtering out product data based on the inventory data.

FIG. 10B illustrates example database tables for storing information according to another embodiment of the present invention. Product data from websites 1060 may be received by the system and used to populated tables of a database. As mentioned above, inventory data may be used to filter the product data for specific stores. For example, a particular store may have inventory data 1061 that includes a list of products and/or categories that are offered by that store. If a product existing in the inventory data matches product data from the website (e.g., if a product ID from the inventory data matches a product ID from the website), then the data retrieved from the product webpage having the matching data element may be passed through and stored in a product table for the particular store. Similarly, if a category in the inventory data matches category data retrieved from the website, then an entire category of product data, which may include a plurality of individual products, may be passed through so that a corresponding plurality of product data records are stored in the product data table for that store. As illustrated at 1062, an alternative approach may include receiving an inventory data list of products and categories not offered by a particular store. In this case, product data from the website is not stored in the product data table for a specific store if the inventory data for that store indicates that a product or category of products is not offered by the store.

As an example, a retailer table 1030 may include multiple records 1031-1033 (e.g., one for each retailer). Each record may include retailer ID, retailer metadata ID (“R_MD_ID”), and other information about the retailer describe above. The retailer metadata ID is used to associate the retailer table with table 1060 as illustrated at 1052, where the product data retrieved from the website of a retailer is stored. In this example, retailer table 1060 includes a product data record for each product including a plurality of fields such as product ID, product name (“PNAME”), price, and any other data related to the product that was extracted from the website.

Product data for specific retailers may be used to populate product data tables for specific stores using the retailer ID and the store inventory data. For example, a store table 1020 includes a plurality store records 1021-1023 (e.g., one for each store). These store records may be for stores for different retailers in a variety of different defined areas. Each store record may include a retailer ID, an ID for the defined area (e.g., a geographic location ID or “GL ID”), and a metadata ID for associating each store with a table 1040 storing product data for the products offered by that store. The retailer ID in each store record associates the store with a retailer as illustrated at 1051. Store product table 1040 includes a plurality of product data records. Each record represents a product offered by the store and stores information about the product. The product data in each record may be populated from the retailer data as described above.

Product data for a plurality of individual products offered by a plurality of individual stores in a defined area may be searched. A location table may store IDs for a plurality of geographic location records to represent different defined areas, such as a mall. Each record may include an ID, as described above. As mentioned above, a plurality of stores may be represented as individual store records with associated product data representing the products offered by each store. Store records may include one of the geographic location IDs. Accordingly, if a store includes the geographic ID for a defined area, there is an association 1050 between the store and the defined area. Accordingly, when a search query is received, the search query may be automatically associated with a geographic location ID (e.g., if the search query is received through the website for a particular mall, the ID for the mall may be associate with the query). The search system may search the store product data tables only for store records having a matching geographic location ID. The search system may then match the product data for these stores against the search query to determine if specific products are offered.

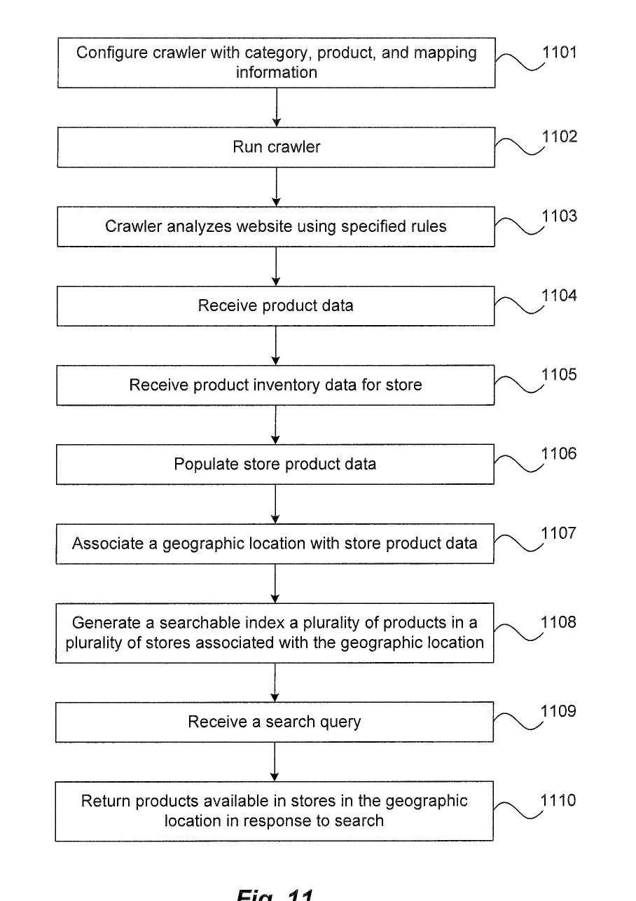

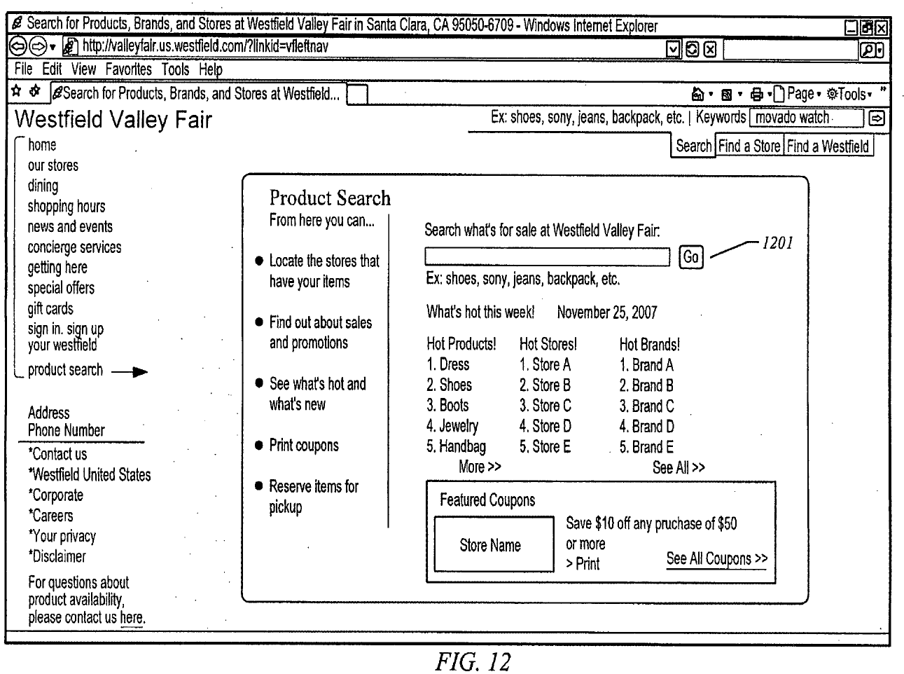

FIG. 11 illustrates a method according to another embodiment of the present invention. At 1101, a crawler is configured with category, product, and mapping information for retrieving product data from web pages. At 1102, the crawler is run, and at 1103 the crawler analyzes the website using the specified rules. At 1104, product data is received. The product data may be stored as a data record for each product having a plurality of associated fields described above. One or more categories may also be extracted from the website and stored as a field for each product. At 1105, product inventory data is received from one or more stores. At 1106, each store product data table is populated. At 1107, a defined area or geographic location is associated with the store product data. At 1108, a searchable index for a plurality of products in a plurality of stores associated with a defined area or geographic location is generated. At 1109, a search query is received. At 1110, products available in stores in the defined area or geographic location are returned in response to the search. Web pages generated by a area search system according to one embodiment of the present invention are presented in FIGS. 12-17 below.

FIG. 12 illustrates a webpage according to one embodiment of the present invention. In this example, a shopping mall website (“Westfield Valley Fair®”) may be accessed by a user, and an area search engine may be integrated into the site at 1201 as described above. A user may enter a search term into the field and click the “GO” button to initiate a search for goods and services. In this example, the shopping mall is the defined area, and the search will be limited to goods and services available in stores in the mall.

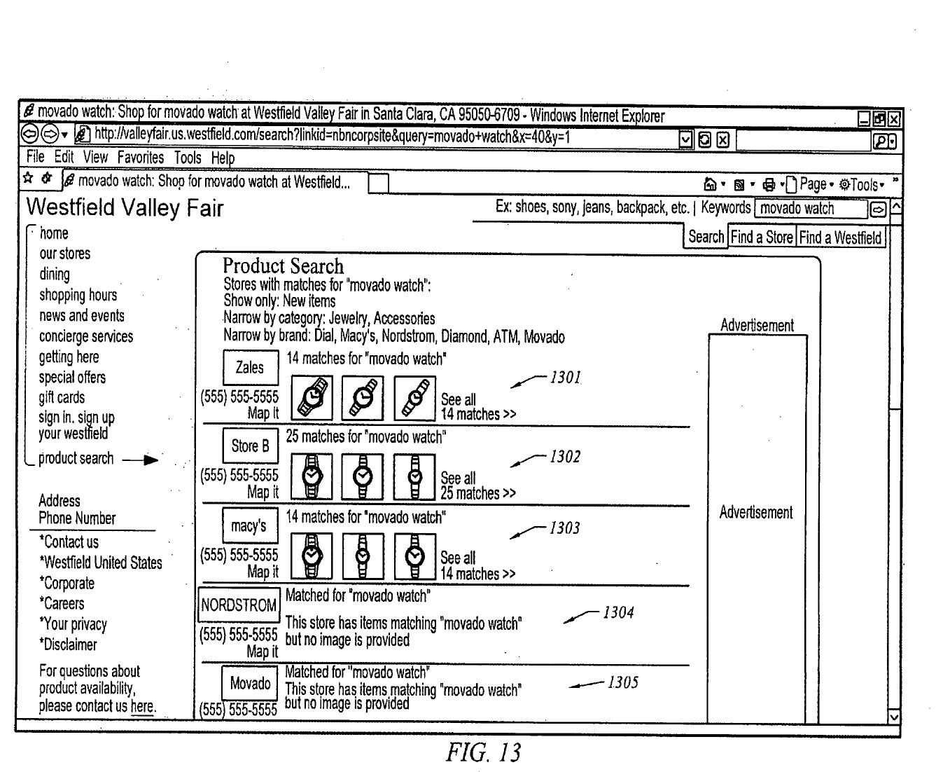

FIG. 13 illustrates a webpage of search results for a shopping mall according to one embodiment of the present invention. In this case, the search term as “movado watch.” The search has determined that five (5) stores in the shopping mall offer Movado® watches. The stores that have corresponding product data including the terms “Movado watch” are illustrated at 1301-1305. Some of the stores have had their logos retrieved as part of the website extraction process described above. Additionally, some of the stores have product data available for display to the user in response to the search. For example, images of the first three product results are displayed next to the stores logo at 1301, 1302, and 1303, with additional matches available through a link. For store results 1304 and 1305, the stores have product data matching the search term, but no images are available for display.

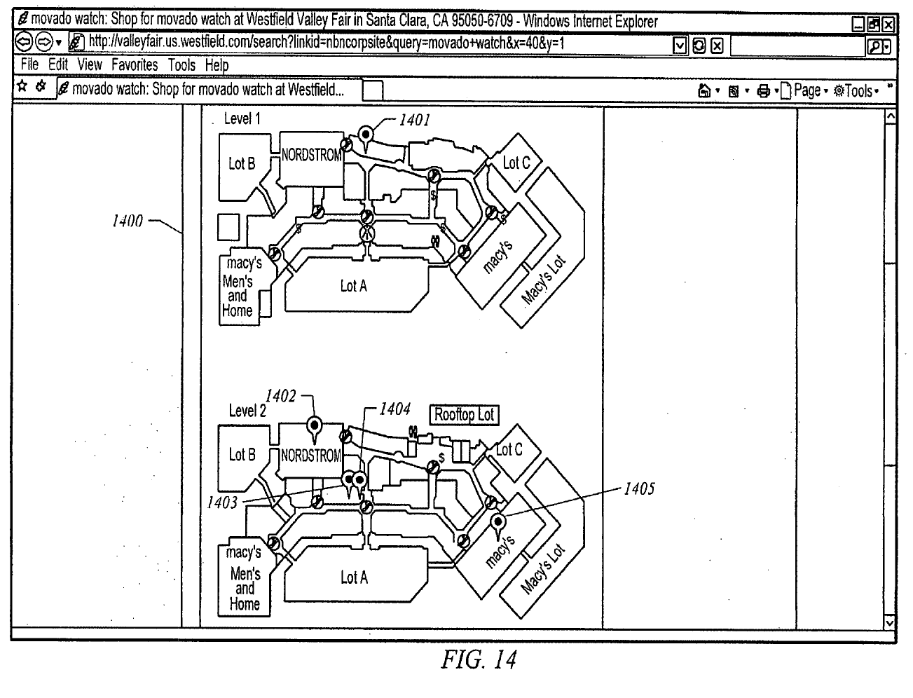

FIG. 14 illustrates a map including store locations according to one embodiment of the present invention. The map 1400 may be displayed on a web page to help users navigate to the stores where the specific products they desire are available. In this example, the map is a graphical image of a two level shopping mall. The map image may be retrieved in response to the search, and using the store information where the products are available, store location information may be determined and superimposed on the map. Here, the store locations are graphical objects similar to markers. Each marker is located on the map at the position of one store returned in the search result. For instance, marker 1401 identifies the location of the Movado® store, marker 1401 identifies the location of Nordstom®, marker 1403 identifies the location of Zales®, marker 1404 identifies the location of Helzberg Diamonds®, and marker 1405 identifies the location of Macy's®.

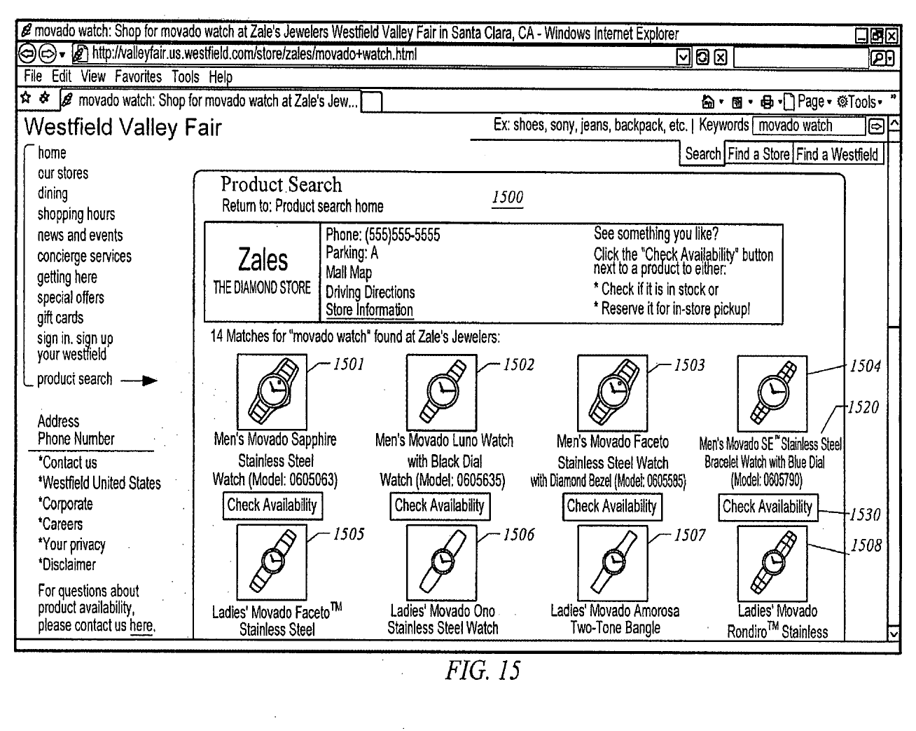

FIG. 15 illustrates product data results of search in a shopping mall according to one embodiment of the present invention. Web page 1500 may be returned to a user if the user selects the “See all x matches” link on the initial results page. Page 1500 may include images 1501-1508 for all the products with product data that match the search query for a particular store. Here, all the Movado® watches available at Zales® are displayed to the user. Additionally, product descriptions 1520 retrieved from the retailer's website may be incorporated into the page proximate to each product image. Additionally, electronic buttons 1530 for checking availability may be incorporated into the page that allow a user to verify the availability of the item as described above.

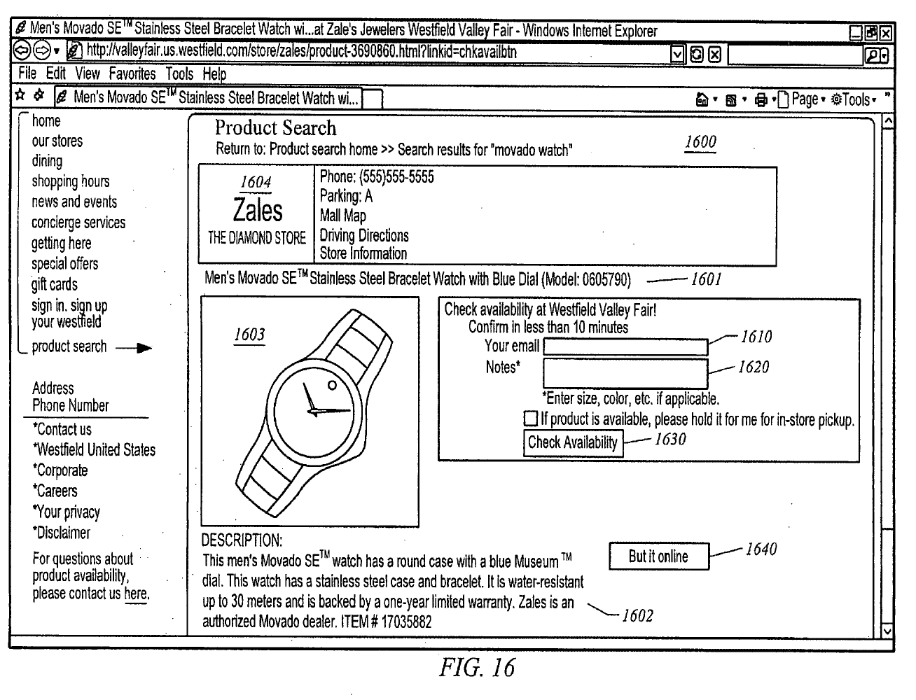

FIG. 16 illustrates a results page for a product with a check availability feature according to one embodiment of the present invention. Web page 1600 is a product specific page that may be used to display a variety of detailed product data to the user as desired. As mentioned previously, this information may be retrieved from the retailer's website or inventory data. In this example, a product title and model number are displayed at 1601, a detailed product description is displayed at 1602, and an image of the product is displayed at 1603. The logo for the store where the product is available is presented at 1604. In this example, a user may check availability of the product by entering an email at 1610 and any notes such as special instructions at 1620 (e.g., size, color, etc. . . . ). Check availability is initiated when the user mouse clicks electronic button 1630. Once a shopper finds a specific product they desire, they can click “check availability” a button 1630, and the availability of the product is verified either automatically or manually. A response may then be sent over email to inform the customer of the result. A link to the product web page from the retailer's website may also be included on page 1600 to allow a user to purchase the product online (e.g., button 1640, “Buy it online”).

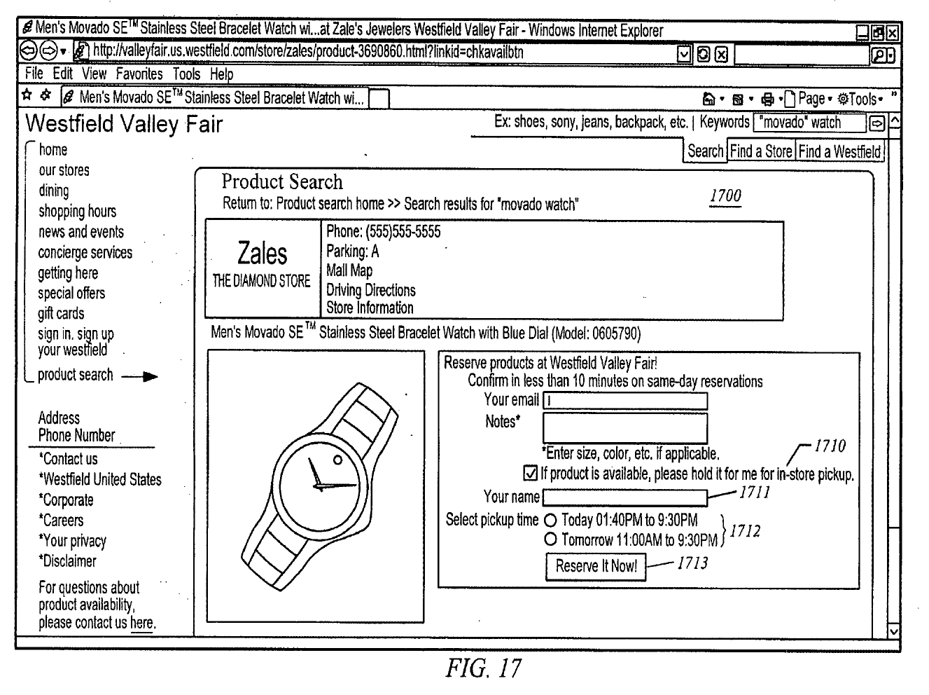

FIG. 17 illustrates a results page for a product with a reservation feature according to one embodiment of the present invention. In this example, the “in store pickup” check box 1710 has been selected using a mouse-click, and web page 1700 includes reservation functionality. A user may be prompted to enter their name at 1711 and a pickup time 1712. The reservation is initiated when the “Reserve It Now” button 1713 is selected. An example of manually processing a request when a shopper clicks “Reserve It Now” button 1713 is as follows. First, the data fields from the web page may be checked to make sure all information has been provided (e.g., email, name, pickup time). The email address may be checked for validity. The request is packaged into an email, which is processed by the server. The server takes incoming requests from all products for all stores in all malls and manages the queue of requests for one or more call centers. An alert (or “ticket”) is created for the concierge (customer service) staff to process, including all the information about the request (item, item specifics, user-provided data, etc.). If the store supports online inventory requests, an inventory request may be processed according to the store's specifications. For example, some stores may allow shoppers to buy online and pick up in store. Such online sites may be used to determine if items are currently in stock without a phone call. If the retailer cannot process an automated inventory request, then the ticket is presented to the concierge staff on a computer screen, along with information about the store and/or retailer such as contact info, hold policies, hours of operation, etc., and the time required to process the request. The concierge reviews the information and places a call to the retailer to determine if the item is available. The concierge staff then relays information back to the shopper in the form of an email or text message. If additional information is required, the concierge can request that information. If the product is not available, an online link may be provided so that the shopper can purchase the item online. When the process is complete, the shopper has either (1) a reserved product waiting for them, or (2) knowledge that the product is not available as specified but a place to buy it online.

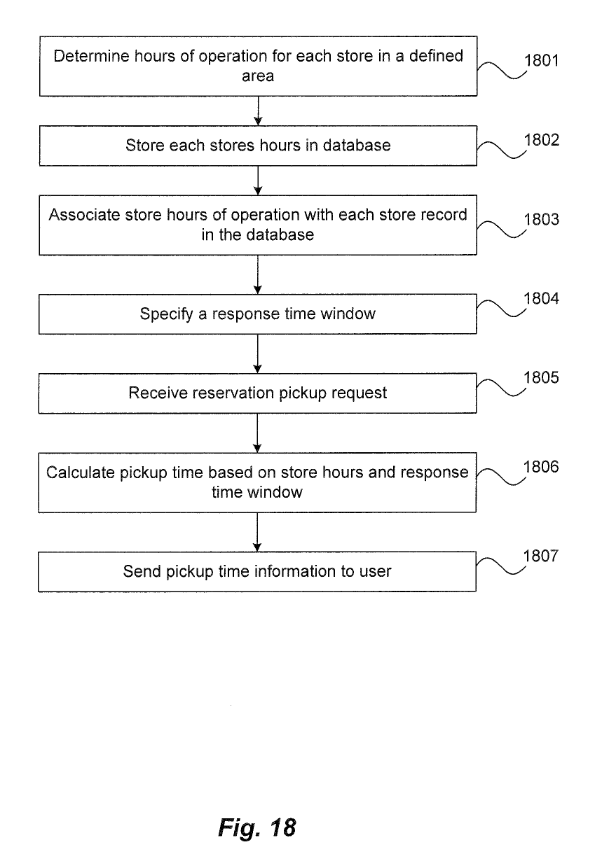

FIG. 18 illustrates method of reserving products for pickup according to one embodiment of the present invention. As discussed with regard to FIG. 17 if a user specifies a product reservation request by selecting check box 1710, the area search system generates customized pickup time information. For example, at 1801 the hours of operation of each store in a defined area may be determined. For example, if all the stores in a mall open and close when the mall opens, then each store may have the same hours of operation as the mall (e.g., Monday through Thursday from 10 am to 7 pm, Friday from 10 am to 9 pm, Saturday from 9 am to 11 pm, and Sunday from 11 am to 6 pm). Alternatively, different stores in a defined area may have different individual hours of operation. At 1802, the store hours of operation are stored in a database, and at 1803 the store hours of operation are associated with each store record in the database. For example, if the defined area is a mall, each store record may have a field indicating that the hours of operation are stored in the record for the specific defined area (e.g., a record for the mall). Alternatively, each stores hours of operation may be stored as one or more fields with each store data record in a stores data table. At 1804, a response time window is specified. The response time window represents the amount of time between the time a user indicates a desire to reserve a product and a time when the product is available for pickup. Different implementations of the system may require different response times. For example, a response time window may be longer in a system where a concierge calls a store to make the reservation than a system where the item is reserved automatically over a network. At 1805, the reservation pickup request is received. For example, if a user selects the “in store pickup” check box 1710, the check box selection may trigger a reservation pickup request. At 1806, the system calculates the pickup time based on the store hours of operation, the current time, and the response time window. For example, the system may offer a user two options for pickup: same day and next day. If the response time window is 2 hours, and if the stores hours of operation are from 9 am to 5 pm daily, then the pickup time displayed to a user will change depending on the time the user initiates the reservation pickup request. For example, if a user initiates the reservation pickup request at 1 pm, then the system will calculate a “same day” pickup time of 2 pm-5 pm (based on the current time of 1 pm, a 2 hour window, and a store closing time of 5 pm) and a next day pickup of 9 am-5 pm. However, if the user initiates a reservation pickup request at 3:15 pm, then the earliest option will be next day pickup. At 1807, the pickup time information is sent to the user as illustrated at 1712 in FIG. 17. Pickup times may be rounded to the nearest quarter hour, for example, or sixth of an hour (e.g., 1:00 pm, 1:10 pm, . . . , 1:50 pm).

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
receiving a plurality of product data, wherein the product data describes a plurality of products offered for sale by a plurality of businesses;
storing the product data as a plurality of individual product data records, wherein each record describes an individual product;
associating a portion of the product data records with a defined physical area, wherein said businesses each have a point-of-sale store located in said defined physical area;
receiving a search request;
searching product data records for a plurality of products in a plurality of point-of-sale stores located in the defined physical area; and
outputting product data for said businesses with point-of-sale stores located in said defined physical area matching said search request.

2. The method of claim 1, the method further comprising receiving product inventory data from a point-of-sale store in said defined physical area, the portion of product data records associated with the defined physical area comprising product data for a first business matching the inventory data from said point-of-sale store for the first business.

3. The method of claim 2 wherein associating a portion of the product data records with a defined physical area comprises associating a point-of-sale store of each business with the defined physical area and associating product data records from each business with the point-of-sale store in the defined physical area.

4. The method of claim 3 wherein the plurality of product data is received from a plurality of websites for said businesses.

5. The method of claim 4, the method further comprising:
configuring an automated web content extraction program with one or more mapping rules for specifying the location of product data in a website; and
extracting the product data from said website of said business.

6. The method of claim 5 wherein the mapping rules mapping product data from a product web page on said website to fields of a product data record in a database.

7. The method of claim 5 wherein the defined physical area is represented by a unique identifier, and wherein associating a portion of the product data with the defined physical area comprises associating a portion of the product data with the unique identifier.

8. The method of claim 1 further comprising:
storing the hours of operation for the first store;
specifying a response time window;
receiving a reservation pickup request;
calculating the pickup time based on the current time, the response time window, and the hours of operation of said store.

9. The method of claim 1 further comprising associating a portion of the product data records with a map image of said defined physical area, and outputting said map image and the location of each point-of-sale store having product data responsive to said search request.

10. The method of claim 1, the method further comprising:
storing an electronic map of the defined physical area;
associating a plurality of stores with location information for specifying the location of the store on said electronic map; and
specifying the location of each point-of-sale store on the electronic map having product data matching said search request.

11. A computer-implemented method comprising:
storing an identifier in a first record, the identifier representing a defined area;
associating the identifier in the first record with a plurality of store records in a store table, wherein each store record corresponds to a point-of-sale-store in the defined area;
associating a first store record from the plurality of store records with a first retailer record in a retailer table, the first store record corresponding to a first store in the defined area;
programming a crawler with configuration information for retrieving information from a website of said retail business, the website comprising a plurality of products and corresponding product data, the configuration information comprising one or more rules for mapping product data from a product web page to fields of a product data record in a database;
associating a plurality of product data records populated with data from said website with the first retail record;
receiving inventory data corresponding to said first store record, the inventory data specifying products offered in said first store;
filtering the product data records using the inventory data, wherein the filtered product data records describe products from said website that are offered in said first store; and
associating the filtered product data records with said first store record, and in accordance therewith, associating the filtered product data records with the defined area.

12. The method of claim 11 further comprising:
generating an index of the data in the database;
receiving a search request for information within said defined area;
accessing the product data associated with said defined area in response to the request; and
generating a plurality of web pages, the web pages comprising product data in said defined area responsive to the search request.

13. The method of claim 12 wherein the search request comprises a search query and a specification of the defined area.

14. The method of claim 12 wherein the search request is a text message comprising a search query and a geocode, the method further comprising mapping the geocode to said identifier.

15. The method of claim 12 further comprising:
storing the hours of operation for the first store;
specifying a response time window;
receiving a reservation pickup request;
calculating the pickup time based on the current time, the response time window, and the hours of operation of said store.

16. The method of claim 11, the configuration information further comprising one or more rules for identifying product categories.

17. The method of claim 11, the configuration information further comprising one or more rules for identifying product web pages.

18. The method of claim 11 further comprising storing map of the defined area in the first record and storing a location of said first store in said defined area in said first data record.

19. The method of claim 11 further comprising storing map of the defined area in the first record and storing a location of said first store in said defined area in said first data record.

20. A computer-readable medium containing instructions for controlling a computer system to perform a method comprising:
receiving a plurality of product data, wherein the product data describes a plurality of products offered for sale by a plurality of businesses;
associating a portion of the product data with a defined physical area, wherein said businesses each have a point-of-sale store located in said defined physical area;
receiving a search request;
searching product data for a plurality of products in a plurality of point-of-sale stores associated with the defined physical area; and
outputting product data for said businesses with point-of-sale stores located in said defined physical area matching said search request.

21. The computer-readable medium of claim 20, the method further comprising receiving product inventory data from a point-of-sale store in said defined physical area, the portion of product data associated with the defined physical area comprising product data for a first business matching the inventory data from said point-of-sale store for the first business.

22. The computer-readable medium of claim 21 wherein associating a portion of the product data with a defined physical area comprises associating a point-of-sale store of each business with the defined physical area and associating product data from each business with the point-of-sale store in the defined physical area.

23. The computer-readable medium of claim 22 wherein the plurality of product data is received from a plurality of websites for said businesses.

24. The computer-readable medium of claim 23, the method further comprising:
configuring an automated web content extraction program with one or more mapping rules for specifying the location of product data in a website; and
extracting the product data from said website of said business.

25. The computer-readable medium of claim 24 wherein the defined physical area is represented by a unique identifier, and wherein associating a portion of the product data with the defined physical area comprises associating a portion of the product data with the unique identifier.

26. The computer-readable medium of claim 25, the method further comprising:
storing an electronic map of the defined physical area;
associating a plurality of stores with location information for specifying the location of the store on said electronic map; and
specifying the location of each point-of-sale store on the electronic map having product data matching said search request.
